(19) United States
(12) Patent Application Publication
(10) Pub. No.: US 2017/0167465 A1
(43) Pub. Date: Jun. 15, 2017

(54) WAVE ENERGY CONVERTER

(71) Applicant: Okinawa Institute of Science and Technology School Corporation, Okinawa (JP)

(72) Inventor: Tsumoru SHINTAKE, Okinawa (JP)

(73) Assignee: Okinawa Institute of Science and Technology School Corporation, Okinawa (JP)

(21) Appl. No.: 15/325,403

(22) PCT Filed: Jul. 15, 2015
(86) PCT No.: PCT/JP2015/003576

§ 371 Date: Jan. 10, 2017

Related U.S. Application Data
(60) Provisional application No. 62/024,790, filed on Jul. 15, 2014.

(51) Int. Cl. F03B 13/22; F03B 13/14

(52) U.S. Cl. CPC F03B 13/22; F03B 13/14; F05B 2240/40; F05B 2240/30; F05B 2240/91

(57) ABSTRACT

A wave energy converter system includes a plurality of wave energy converter units installed at or adjacent to a shoreline to receive water flows caused by ocean waves approaching the shoreline, each of the wave energy converter units including: a generator having a rotor shaft, the generator being configured to generate electricity in accordance with rotation of the rotor shaft; and a plurality of blades attached to the rotor shaft, the plurality of blades causing the rotor shaft of the generator to rotate in response to the water flows that impinge on the blades, thereby generating electricity; and a power conditioner installed onshore to receive the electricity generated by each of the plurality of wave energy converter units, the power conditioner providing consolidated electricity to an external power grid.

### TECHNICAL FIELD

The present invention relates to a wave energy converter system, and more particularly to a wave energy converter system converting nearshore/onshore wave energy to electric power. This application hereby incorporates by reference United States Provisional Application No. 62/024,790, filed Jul. 15, 2014, in its entirety.

### BACKGROUND ART

Numerous attempts have been made in recent years to utilize renewable energy on the earth as a supplement or alternative to the existing energy sources. In particular, ocean energy, such as offshore ocean wave energy, nearshore wave energy, and onshore wave energy, has been the subject to intensive research and development. A review of the wave energy technology can be found in a review article by Lopez, et al., for example, listed below as Non-Patent Literature (NPL) No. 1.

As shown in NPL 1, for example, until recently, various types of the wave energy converters have been proposed and tested. Some of them use a floating body on the water surface and harness ocean energy from vertical motion of oscillation on the ocean wave offshore. Another one uses a vertical vessel to convert wave motion into airflow, followed by air turbines to generate electricity. However, most of these R & Ds failed due to (1) low energy-conversion efficiency, (2) mechanical breakdown in storm conditions, (3) expensive installation, thereby not meeting economical requirements, and/or (4) unreliable design for operation for a long period of time.

### CITATION LIST

### Non Patent Literature

NPL 1: I. Lopez, et al., Review of wave energy technologies and the necessary power-equipment, Renewable and Sustainable Energy Reviews 27 (2013) 413-434

### SUMMARY OF INVENTION

### Technical Problem

Thus, various systems utilizing different forms of wave energy, such as offshore, nearshore, onshore wave or pressure differences between the surface and the bottom have been proposed and tested. Different systems have different advantages and disadvantages. Yet, economical and efficient power generating systems have not yet built and established. Researchers and engineers in this field are constantly pursuing new, economical, and efficient designs for utilizing wave energy for electric power generation.

The present invention is directed to a wave energy converter unit/system, and more particularly, to a wave energy converter unit/system converting nearshore/onshore wave energy to electric power.

An object of the present invention is to provide a new and improved waver energy converter unit and a power generation system incorporating the same so as to obviate one or more of the problems of the existing art.

### Solution to Problem

To achieve these and other advantages and in accordance with the purpose of the present invention, as embodied and broadly described, in one aspect, the present invention provides a wave energy converter system, including: a plurality of wave energy converter units installed at or adjacent to a shoreline to receive water flows caused by ocean waves approaching the shoreline, each of the wave energy converter units including: a generator having a rotor shaft, the generator being configured to generate electricity in accordance with rotation of the rotor shaft; and a plurality of blades attached to the rotor shaft, the plurality of blades causing the rotor shaft of the generator to rotate in response to the water flows that impinge on the blades, thereby generating electricity; and a power conditioner installed onshore to receive the electricity generated by each of the plurality of wave energy converter units, the power conditioner providing consolidated electricity to an external power grid.

In another aspect, the present invention provides a wave energy converter unit with adaptive pitch blades for converting ocean wave energy to electric power, including: a generator having a rotor shaft, the generator being configured to generate electricity in accordance with rotation of the rotor shaft; and a plurality of adaptive pitch blades attached to the rotor shaft, the plurality of blades causing the rotor shaft of the generator to rotate in response to water flows of ocean waves that impinge on the blades, thereby generating electricity, wherein each adaptive pitch blade has a spar shaft at a leading edge of the blade, the spar shaft being fixed to the rotor shaft and radially extending from the rotor shaft, and wherein at least some segments of the blade are configured to be elastically rotatable around the spar shaft relative to a prescribed neutral rest position so that said at least some segments of the blade can change a pitch angle relative to the spar shaft in response to the water flows of the ocean waves that impinge on the blade. A plurality of such wave energy converter units may be used for the wave energy converter system described above.

### Advantageous Effects of Invention

According to one or more aspects of the present invention, it becomes possible to provide an efficient and economical wave energy converter and a system incorporating the same. In at least some of the embodiments of the present invention disclosed herein, the design is simple and intelligent. Installation will be on-shore (very close to the shore), and thus maintenance is easy. In combination with existing wave dissipating structure, such as tetrapods, installation cost will be dramatically reduced. Further, it will be not harmful to the environment, rather it helps wave breaking structures. Furthermore, according to at least some of the aspects of the present invention for wave energy converter units with adjustable pitch blades, a wide range of environment changes, such as extremely high water flow due to severe weather conditions can be effectively dealt with, and can be handled with low maintenance costs.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory, and are intended to provide further explanation of the invention as claimed.

### BRIEF DESCRIPTION OF DRAWINGS

FIG. 1 schematically shows a wave energy converter unit installed adjacent to the shore according to an embodiment of the present invention.

FIG. 2 is a schematic drawing showing a wave energy converter system installed adjacent to the shore according to an embodiment of the present invention.

FIG. 3 shows an example of the wave energy converter unit of FIG. 1 in more detail.

FIG. 4A is a front view of another example of the wave energy converter unit of FIG. 1.

FIG. 4B shows a side view of the wave energy converter unit of FIG. 4A.

FIG. 5 is a schematic diagram showing an example of an electric configuration of a wave energy converter system according to an embodiment of the present invention.

FIG. 6 a graph showing a relationship between the fluid velocity versus the electric power output for a turbine with fixed blades and for a turbine with variable pitch blades.

FIG. 7 shows an operational principle of a blade used in a wave energy converter according to an embodiment of the present invention.

FIG. 8 shows an operational principle of the blade shown in FIG. 7, when the water flow rate is extremely high.

FIG. 9 shows an exemplary way of winding spiral ply cords of an adaptive pitch rotation blade according to an embodiment of the present invention.

FIG. 10 shows the adaptive pitch rotation blade for which the spiral ply cords are wound in accordance with the method explained with reference to FIG. 9.

FIG. 11 shows an adaptive pitch rotation blade according to an embodiment of the present invention.

FIG. 12 shows an adaptive pitch rotation blade according to an embodiment of the present invention.

FIG. 13 shows a WEC unit that has been actually built according to an embodiment of the present invention.

FIG. 14 shows another example of installation of WEC units at a shoreline according to an embodiment of the present invention.

FIG. 15 shows yet another example of installation of WEC units at a shoreline according to an embodiment of the present invention.

### Description of Embodiments

The present disclosure provides, in one aspect, a turbine with appropriately designed rotatable blades for Wave Energy Converter (WEC) to harness ocean energy to convert into electricity from flows of water in the onshore breaking waves. In some embodiments, a plurality of such turbines are installed near the shore so that forward and backward flows of the coastal waves near the coast line cause the rotations of the blades, thereby constituting a wave energy converter system that generates electricity. The ocean waves are normally mixed with vortex flows and air bubbles. Thus, the turbine has to run inside highly non-uniform multi-phase flows. When the ocean wave approaches to a shore, forward motion of wave crest becomes dominant. Because the sea floor acts as a drag force, the wave crest runs faster than the bottom, starting to break. In at least some of the embodiments disclosed herein, this fast running water slope has been used for surfing; here the present disclosure uses it for energy generation.

In contrast to the wave dynamics near the shore, in deep water, water particles are moving on circular motions. Such up-down motion has been utilized as some of WECs as described in NPL No. 1 listed above.

<Wave Energy Converter Unit>

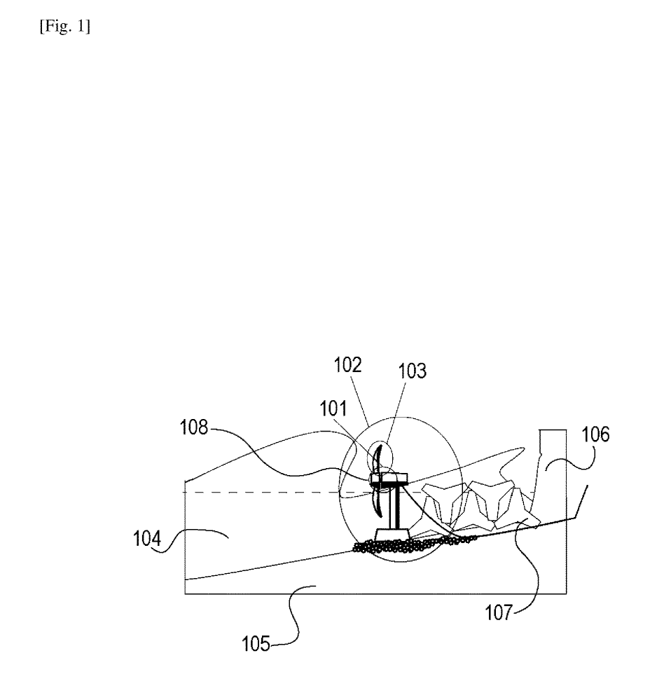

FIG. 1 shows a wave energy converter unit installed adjacent to the shore according to an embodiment of the present invention. Near the coast line (in this example, bank 106), a WEC unit 102 is installed on the seabed 105. The WEC unit 102 has a plurality of rotatable blades 103 rotating along a shaft that is connected to an electric generator 101. In one design, the WEC unit is installed near tetrapods 107 so as to face the offshore such that the average level of the sea water 104 primarily hits the rotatable blades 103, for example, so that incoming wave crest will efficiently rotate the blades. Thus, the WEC unit of this embodiment utilizes horizontal water flows in the waves. In one embodiment, only one directional flows can be utilized in the WEC unit to generate power, but as described below, bi-directional flows can be utilized in some other embodiments. Breaking waves cause the blades 103 to rotate, and electricity is generated due to the rotation through the electric generator 101.

The blades are preferably made of a flexible material so that an extremely high rate of water flow does not easily damage the integrity of the blades. Also, as disclosed below, in some embodiments, the blades 103 may be configured to change its attack angle (i.e. pitch or twist angle) in accordance with the speed of incoming flow of water due to the waves so as to maximize power conversion efficiency and to avoid too much stress on the blade.

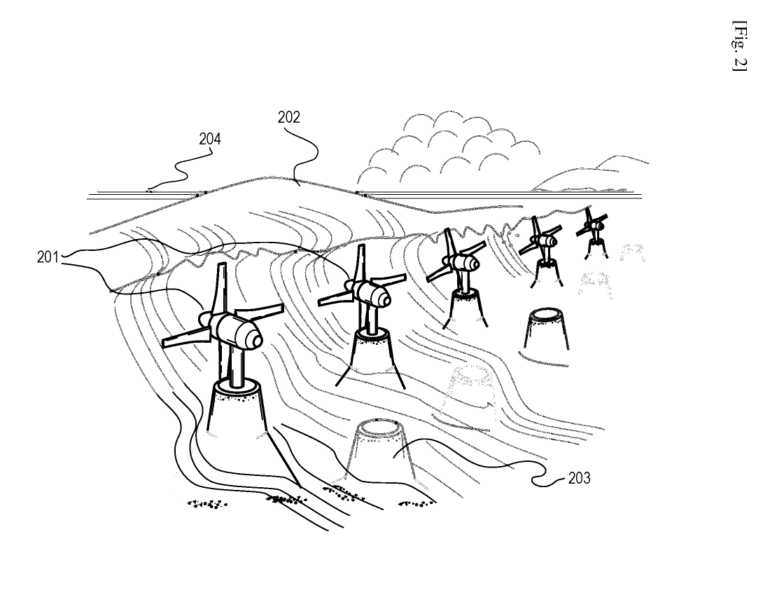

FIG. 2 is a schematic drawing showing a wave energy converter (WEC) system installed adjacent to the shore according to an embodiment of the present invention. The figure shows the WEC system as seen from the shore towards the ocean horizon 204. As shown in the figure, a plurality of the WEC units 201, for example, the one shown in FIG. 1 above, may be installed along the coast line so that a large amount of electricity can be generated, and so that the time-averaged total power generated is fairly constant and easily manageable. According to the ocean wave theory, when the ocean wave 202 is approaching to the shore, the wave energy is concentrated around the surface due to narrowing boundaries between the water surface and the slope of the seabed. As a result, the wave height becomes higher and higher, and finally it reaches to the critical point and breaks. Right before the wave 202 breaks, the velocity of the water flow reaches about 5 to 10 m/sec in the direction facing the shore in typical wave conditions (a few meter high). By placing a rotating turbine in this water flow, electricity can be generated. Since this process is direct and there is no intermediate process, the energy conversion efficiency is fairly high. Using an array of this type of generators in a plurality, a large amount of wave energy can be harnessed. By temporarily storing the generated electricity in a capacitor bank, the regulated AC power can be transmitted to the power grid through a proper power conditioner. The beating or other forms of pulses from the breaking waves can be averaged out. The size of the generator can be made small. For example, the diameter of the blade may be about 2 m, and thus handling and installation do not pose significant problems. By utilizing today's advanced technologies from electric motor cars (generator, battery and power converter), this type of reliable WECs can be manufactured at low cost. A combination of this type of WEC units and the existing wave extinguishing tetrapods 203 is a preferred configuration; energy can be taken from the wave and the shore can be protected from soil loss and salty water.

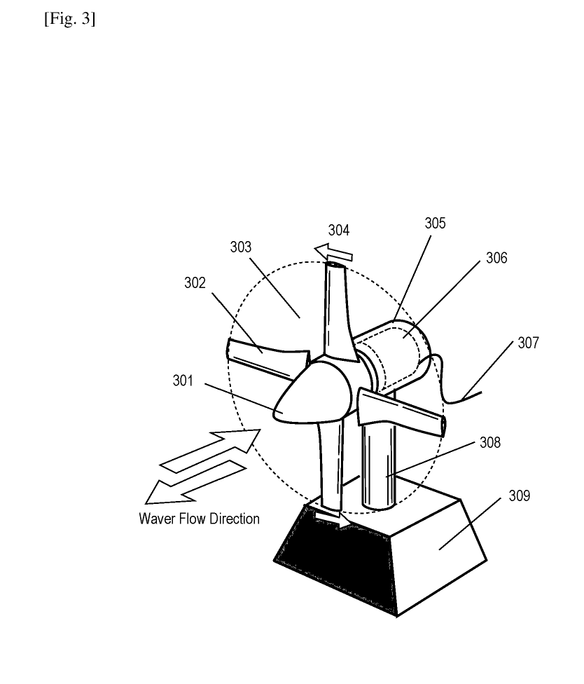

FIG. 3 shows an example of the wave energy converter (WEC) unit of FIG. 1 in more detail according to an embodiment of the present invention. As shown in the figure, the WEC unit of this embodiment includes a nose cone 301, blades 302, which rotate in the direction 304, and a housing 305 for housing a generator 306. These parts collectively constitute a turbine 303. The turbine 303 is supported by support shaft 308 fixed on support base 309. Cable 307 is attached to the generator 306 to transfer the generated electricity to the shore.

The WEC unit of FIG. 3 can be installed near the shore at locations where the mean sea depth is about 1 m to 5 m, for example. Shoreline waves create fast horizontal flows of water toward onshore direction and backward repeatedly. The WEC unit is placed as its turbine axis being oriented roughly perpendicular to the shoreline or in the direction in which incoming wavers travel so that the blades rotate efficiently in response to the incoming waves (and, as disclosed below, also in response to outgoing/backward waves).

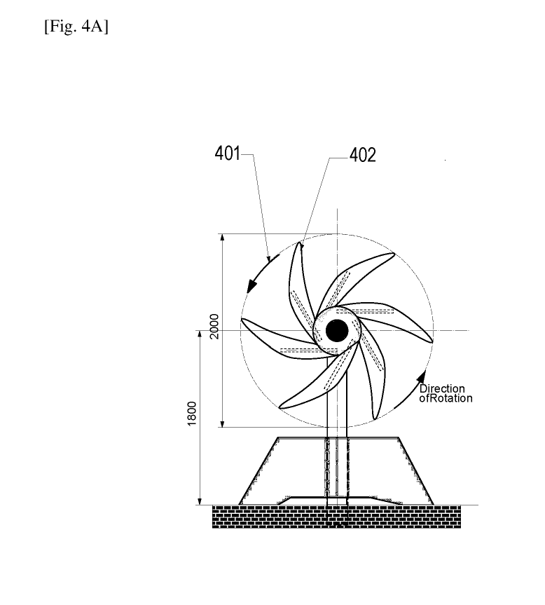

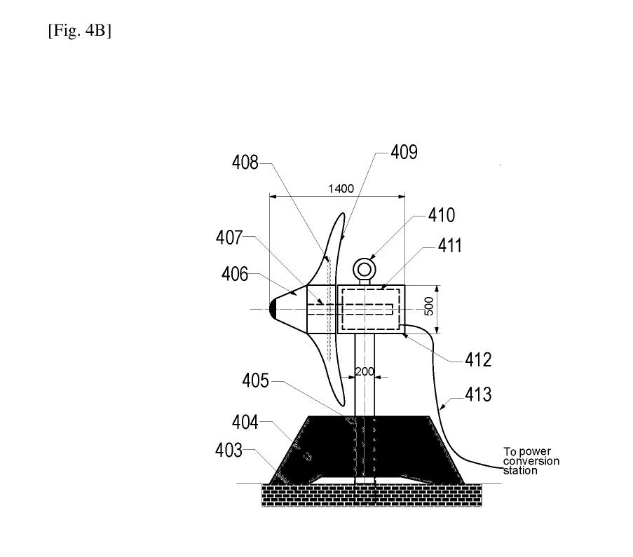

FIG. 4A is a front view of another embodiment for the wave energy converter (WEC) unit. FIG. 4B is a side view of the wave energy converter unit of FIG. 4A. As shown in FIG. 4B, six (6) rotor blades 409 are provided in this embodiment. The blades 409 (shown as blades 402 in FIG. 4A) are constructed of a rubber material reinforced by a cross ply. The blades 409 are detachably mounted for ease of maintenance. Metal rod 408 is provided as the spar for each blade and is attached to the rotor shaft 407. This WEC unit also includes a propeller nose cone 406 made by fiber reinforced polymer (FRP) or glass fiber reinforced polymer (GFRP) attached to the rotor shaft 407, a housing 412 made by FRP or aluminum, for example, for housing electric generator 411, a lifting hook 410 for installation, a pier shaft 405 for supporting the housing 411, and an output power cable 413 for connection to a power conversion station. The pier shaft 405 is supported by base slab steel 404, which weighs, for example, 10 tons and which is placed on a sand or crushed rock foundation 403 formed on the seabed. Small numerical characters in FIG. 4A and FIG. 4B indicate approximate preferred dimensions of the respective sizes in the unit of millimeters. An estimated rotation speed is about 1 to 3 Hz; 60 to 180 rpm. The shape and dimensions of the blades 402 (409) depend on the site conditions, such as water depth and speed, and can be appropriately designed using aerodynamic simulation, for example.

<Wave Energy Converter System>

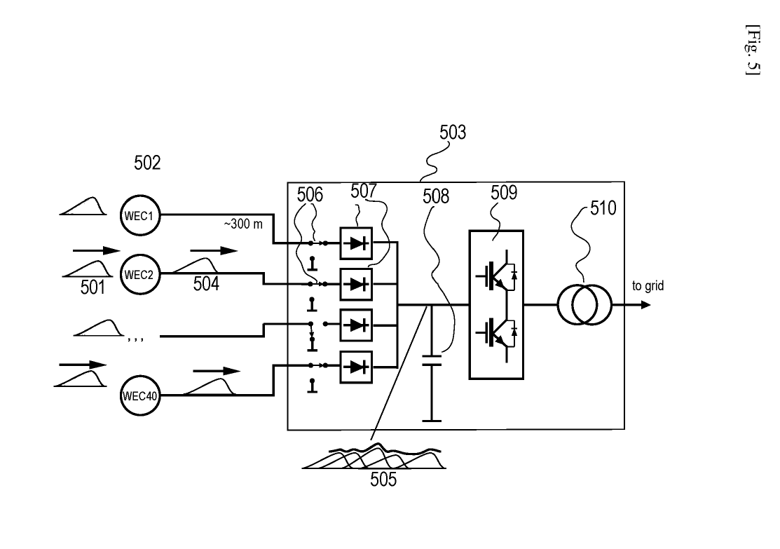

FIG. 5 is a schematic diagram showing an example of an electric configuration of a wave energy converter system according to an embodiment of the present invention. A plurality of WEC units WEC1 to WEC40 are installed in the ocean near the shore (or at the shore) to construct, so to speak, a WEC farm in a relatively small scale. In this embodiment, each WEC unit has a 2 m diameter turbine with a 100 kW peak output and 25 kW average rating for nominal wave height of 2 m. These WEC units are arranged at a 5 m interval, spanning a total of 200 m in length along the beach. The generated output power is individually sent by a three-phase power cable 504 at 600 V, 100 A that can be laid at the length of a few hundreds meters (300 m, for example). Each of the WEC units WEC1 to WEC40 receives randomly arriving wave 501 and generates current pulses each typically lasting for a few seconds.

A power conditioner 503 for processing electric power generated from individual WEC units WEC1 through WEC40 is installed onshore. As shown in FIG. 5, each cable 504 from the corresponding WEC unit is connected to a capacitor bank 508 through a connection switch 506 and a rectifier 507 so that the generated AC power is stored temporarily in the capacitor bank 508 as DC power. A DC/AC converter 509 converts the DC power stored in the capacitor bank 508 to AC power and sends it to a step-up transformer 510. The step-up transformer 510 matches the phase and voltage of the AC power with those of an external power grid and sends the adjusted AC power to the external power grid. Since waves randomly reach the shore, power generated from each WEC unit becomes random pulses in time, each pulse duration being a few seconds. The pulse energy from WECs are converted into DC and stored in the capacitor bank 508. Thus, combined currents 505 from a plurality of WECs are stored in the capacitor bank 508. Importantly, the stored energy does not leak out to WECs because of the rectifiers 507. Thus, the rectifiers 507 play two roles; AC/DC conversion and isolation of the WEC unit from the capacitor bank 508 when the WEC unit stops generating power due to absence of waves and/or machine failure. For maintenance, each WEC unit can be isolated by the connection switch 506.

The stored energy in capacitor back 508 is sent to the power grid through the DC/AC converter 509 and the step-up transformer 510. As mentioned above, the voltage and phase are regulated by DC/AC converter 509 to match those of grid power conditions for smooth and efficient transfer of power to the power grid. As described above, according to the WEC system of this embodiment, a relatively large amount of electric power can be generated from breaking waves and/or waves coming into the shore. In appropriate circumstances, this configuration, i.e., an array of rotating blades, can also be applied to offshore waves, to tidal power generation and to hydropower generation in river flows.

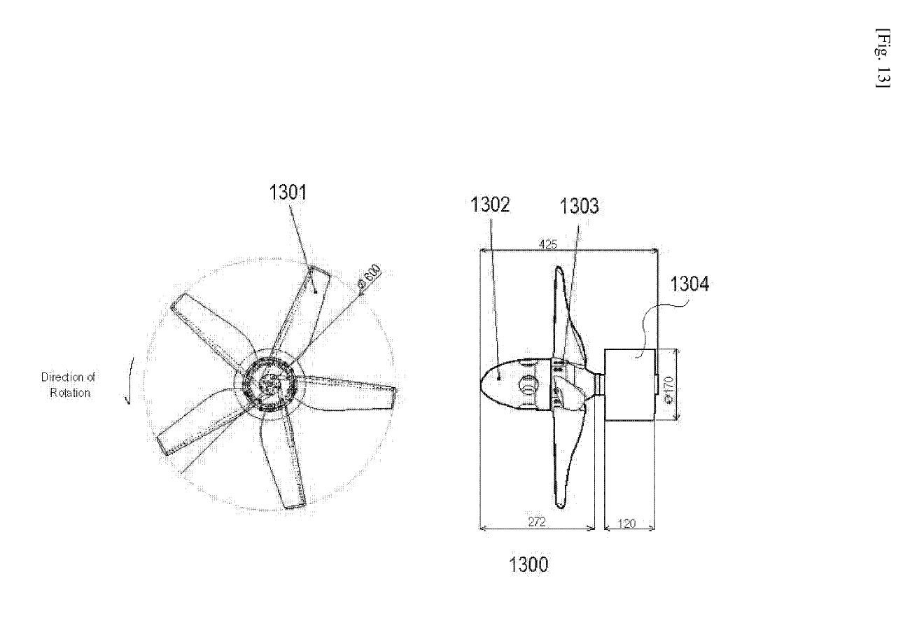

The inventor has confirmed the operability of the WEC unit and WEC system described above by the following experiment. FIG. 13 shows a WEC unit 1300 that has been actually built according to an embodiment of the present invention. A left figure of FIG. 13 is a front view and a right figure of FIG. 13 is a side view. The WEC unit 1300 has five (5) blades 1301 that are each fixed to a rotor hub 1303 with four (4) bolts and supported by a carbon shaft inserted therein to withstand drag force generated by incoming waves. Each blade 1301 was shaped in accordance with NACA0020-0018 mixed specifications, and was made of ABS (Acrylonitrile Butadiene Styrene) resin using a 3D printer. The rotating span of the blades was set to 600 mm in diameter. A nosecone 1302 is attached to the rotor hub 1303. A three-phase AC generator 1304 is attached to the rotor hub 1303 to convert rotational energy of the blades 1301 to electric power. Numerical values in the drawing show dimensions of the respective portions in the unit of millimeters. Model WPT100-20WE generator manufactured by Winpowertech was used for the generator 1304. The nominal output power of the generator was 100.1 W for the input power of 126.6 W, having an efficiency of 79.03%.

The WEC unit 1300 was placed in ocean water at Maeda beach in Okinawa prefecture, Japan. In the experiment, roughly the bottom half of the turbine (WEC unit 1300) was submerged in the average sea level. The wave height at the experiment site was about a few tens of centimeters to a few meters. The power generated was evaluated by a load resistor having a resistance of 233 ohms that is connected to output terminals of a three-phase rectifier, which rectified the three-phase AC output from the generator 1304. The maximum power observed was 101.7 W at the load resistor. The calculated water speed was 1.4 m/s, which corresponds to a rotation speed of about 200 rpm. This experimental result indicates a significant efficiency in the power conversion, and the practical utility and feasibility of the WEC unit as well as the WEC system described herein have been successfully confirmed.

<Adaptive Pitch Rotatable Blades for WEC Unit>

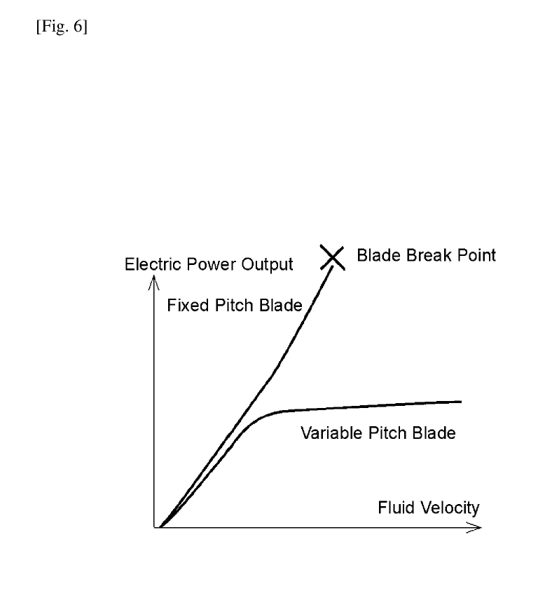

In some embodiments of the present invention, blades for the WEC unit (i.e., turbine) are configured to have a variable pitch, which is adaptive in response to the incoming water flow/wave movement. FIG. 6 is a graph showing a relationship between the fluid velocity versus the electric power output for a turbine with fixed pitch blades and for a turbine with variable pitch blades both according to the present embodiment. The fixed pitch blades have a fixed angle relative to the rod to which the blade is attached (such as metal rod 408 in FIG. 4B). As shown in the curve for the fixed pitch blades in FIG. 6, when the incoming fluid (seawater) velocity increases, the electric power output generated by the fixed pitch blades increases. However, when the fluid velocity is extremely high, the mechanical stress applied to the blades by the seawater may cause the fixed pitch blade to break. Thus, when using fixed-pitch blades, the corresponding WEC unit must be carefully designed considering typical and worst wave conditions at the installation site so as to ensure that the blade break point of FIG. 6 is not reached. As described above, a relatively flexible material, such as rubber, can be used for the material for the blades 302 (or 402/409) to absorb pressure imposed by extremely high fluid flows. However, as alternatives to such a fixed pitch design, the elasticity of the material or elastic structures can be utilized more directly to deal with the problem of blade breakage more effectively. The present disclosure provides several innovative embodiments for such structures, as described below.

Accordingly, in some embodiments of the present invention, an adaptive mechanism is introduced into the turbine, which enables the twist angle of the blades to change automatically and passively according to the flow direction and the local velocity of the wave. The blades according to these embodiments may be made of a flexible material, for example, a rubber. In one embodiment, a rod spar is implemented near the leading edge of the blade to keep the flexible blade in straight form in the absence of the water flow/waves, while the other end of the blade on the opposite side can rotate around the rod spar. A mechanical spring or spring action of rubber may be utilized to keep the airfoil torque at an optimized value to maximize the energy conversion efficiency. In some embodiments, with the periodically alternating flow directions of waves, the blade can automatically changes the direction of twist angle in response to the changes in the direction of the flows; thus the turbine keeps rotating in the same direction. In other words, not only incoming waves, but also outgoing waves can contribute to rotation of the blades in the same prescribed direction, thereby contributing to electrical power generation.

Moreover, there is a large velocity gradient in the breaking wave; i.e., high velocities at the surface and low velocities at the bottom. If a fixed twist angle blade is used, the blade gains the speed near surface, but it looses energy at bottom, and thus the energy conversion efficiency may be sacrificed. By using the adaptive pitch design, the blade takes small angle at bottom and minimizes the drag force, as a result, the turbine does not loose energy at bottom. Further, in storm conditions, this design provides a torque limiting function. At extremely high-speed flows, the blade flips to align with the flow direction, i.e., into the neutral position (zero angle of attack, thus the lift coefficient becomes close to zero), and reduces the lift force from high power flow. As a result, it can be protected from destructive impact due to surge currents. This operational principle is further explained below in the context of describing specific embodiments.

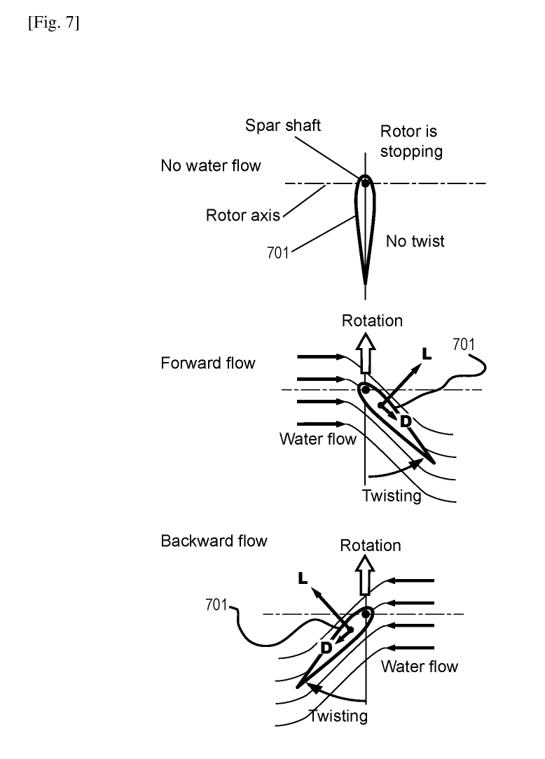

In one aspect of the present invention, each blade or section of the blade is attached to a spar shaft (corresponding to the metal rod 408 in FIG. 4B) in such a manner that it is elastically rotatable around the spar shaft. FIG. 7 schematically shows an operational principle of such a blade according to this embodiment of the present invention. FIG. 7 shows a cross-section of the blade 701 as seen from the radial direction towards the axis/center of the rotation. Incoming/forward water flow comes in from the left to the right in the figure. Referring to FIG. 7, the above-mentioned operational principle is described in more detail. When there is no water flow, the blade 701 is in its neutral position; i.e., the twist (pitch) angle is zero (top figure). In other words, the blade 701 is laid flat in a plane of rotation that is perpendicular to the direction of water flow/wave movements. When the forward wave comes in, the forward flow of water twists the blade 701, which causes the blade 701 to rotate around the rotator shaft (middle figure). When the outgoing (backward) wave comes in, the backward flow of water twists the blade 701 in an opposite direction, and as a result, the blade 701 causes the rotation of the turbine in the same direction (bottom figure).

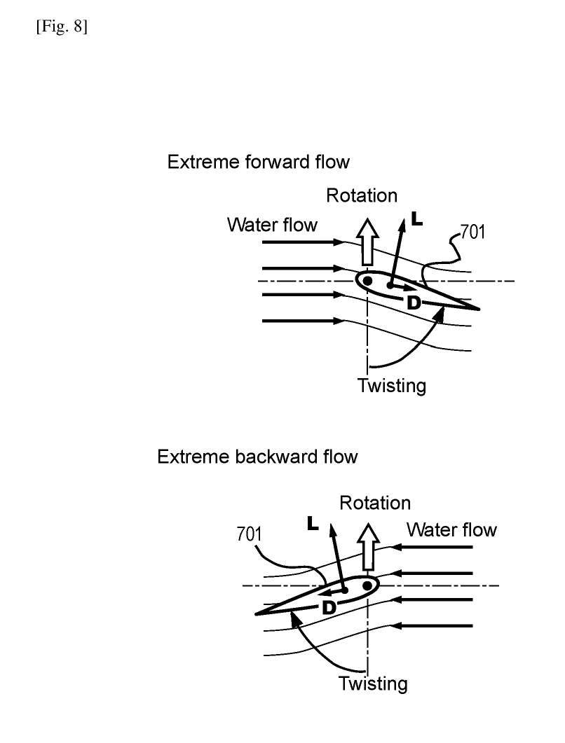

FIG. 8 shows the operational principle of the blade 701 according to this embodiment of the present invention when the water flow speed is extremely high. In extreme conditions, such as a typhoon, waves become very high, and water flows at extremely high speed. Due to the resulting large pressure force, the blade 701 is twisted further, and the angle of attack of the flow relative to the blade surface becomes small; i.e. the blade (or the section of the blade) is twisted at almost 90 degrees relative to the initial rest position. As a result, the lifting force of the blade 701 is limited, resulting in a limited rotation speed. The same limited (or auto-regulated) rotation occurs when extremely high backward flows hit the turbine from the behind. With this mechanism, very high flow rates of waves/seawater impinging on the turbine do not cause impermissibly high stresses on the blade 701 or turbine, thereby preserving the integrity of the WEC unit in an auto-regulating/adaptive manner. In other words, the structure described above is self-torque limiting. This effect is summarized in FIG. 6 discussed above. As shown by the curve for the variable pitch blade in FIG. 6, even when the incoming fluid velocity becomes very large, electric power output is saturated, indicating that the rotation is limited with the very large flow rate. Thus, the WEC unit/system is protected from sever weather conditions. Accordingly, the feature of adaptive pitch rotating blades according to this aspect of the present invention provides an economical and efficient manner to cope with a wide range of wave/ocean conditions. In other words, this feature of the present invention provides auto-regulated torque limiting effects so that the blades are not subject to undesirable large stresses and pressures even when installation sites are occasionally subject to extremely large water flows.

<Examples of Adaptive Pitch Rotation Blades>

The cross-sectional structure of the adaptive pitch rotation blade described above with reference to FIGS. 7 and 8 can be provided through the entire length of the blade in the radial direction, or in some embodiments, can be provided at only one or more segments of the blade in the lengthwise direction, for example.

Adaptive pitch rotation blades according to embodiments of the present invention may be made of a soft material, for example, synthetic rubber or natural rubber, which may be the same material as commonly used in pneumatic tires for automobile. Carbon black may be added to these materials for reinforcement and improvement of lifetime under repeated stress on the blade due to the waves.

The cross-section of the adaptive pitch rotation blade preferably has a streamlined shape. In some embodiments, the shape data from NACA airfoils developed by the National Advisory Committee for Aeronautics (NACA) may be utilized. In some circumstances, symmetrical airfoil shapes are preferable for embodiments of the present invention for the WECs, such as NACA0020 in the four-digit series, because they can respond to forward and backward flows of waves in a symmetrical manner.

Examples of the dimensions of the blades are a diameter of turbine: 2 m; blade length: 0.9 m; blade width 0.3 to 0.1 m tapered, for example.

In some embodiments, the adaptive pitch rotation blades have a long hole near the leading edge to allow a spar to be inserted. In some embodiments, the diameter of the hole is a few millimeters larger than the diameter of the spar so as to allow the blade to twist freely. In some embodiments, the center position of the hole is about 5 to 15% of the chord length measured from the leading edge.

In some embodiments, the neutral angle of the twist is set to zero; i.e., the blade is laid flat at a rest condition. When a wave comes, the flow of the water will push the trailing edge into a downstream direction, and create an appropriate twist angle adaptively. In some embodiments, the blades can be configured such that when generating a target power, the twist angle is 30 to 60 degrees at the bottom (near to rotor axis) and 0 to 3 degree at the wingtip, for example.

The spar for the blades according to various embodiments of the present invention may be made of CFRP (Carbon-fiber-reinforced polymer), GFRP (Glass fiber reinforced plastics), or metal (stainless steel or steel), for example. The spar may have a circular cross-section, i.e., rod shape. The spar may have a tapered shape, i.e., a larger diameter near the generator axis and a smaller diameter toward the wingtip. In some embodiments, the diameter of the spar may be set to 30 mm to 100 mm at the bottom (near to the rotor axis) and 10 mm to 30 mm at the wingtip.

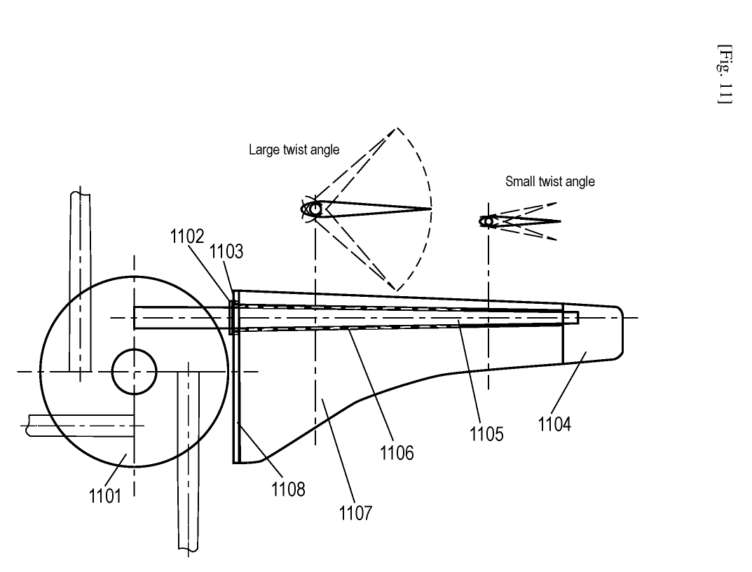

FIG. 11 shows an adaptive pitch rotation blade according to an embodiment of the present invention. In this embodiment, a wingtip 1104 of the blade is fixed to a spar 1105 by inserting the spar into a socket formed in the wingtip 1104, which is made of GFRP, CFRP or metal (stainless steel or aluminum). The spar 1105 is attached to a rotor hub 1101 on the other end. The spar 1105 may be provided with slip rings 1106 made of Teflon or carbon plastic to reduce friction so that these sections of the blade (other than the wingtip 1104) can easily rotate around the spar 1105. The blade has a flexible blade body 1107 made by, for example, rubber. The flexible blade body 1107 is supported by a rib 1108, and the rib 1108 is rotatably attached to the spar 1105 with a bearing 1103 together with a mechanical seal 1102. With this configuration, since the top of the blade body 1107 is affixed to the wing tip 1104 and since other sections of the blade body 1107 is made freely rotatable, the elasticity of the blade body 1107 controls the twisting angle of the blade body 1107 that is generated in response to the incoming waves. As shown in FIG. 11, due to the above-mentioned structure of this embodiment, a lower part of the blade has a wide range of twisting angle in response to the water flow, and a higher part of the blade has a narrower range of twisting angle. Due to this elasticity, the twist angle of the blade (blade sections) is changed in response to water flows.

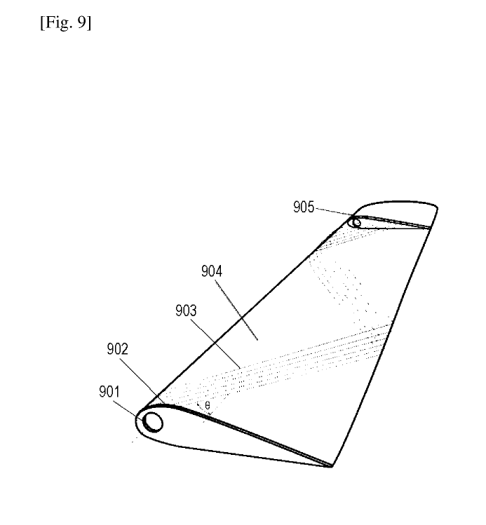

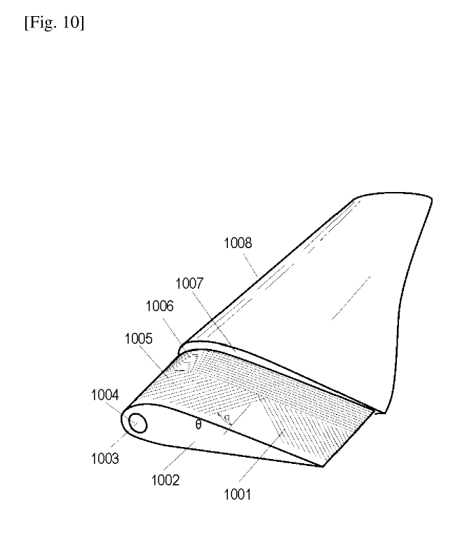

Referring to FIGS. 9 and 10, another embodiment for adaptive pitch rotation blades according to the present invention is explained. FIG. 9 shows an exemplary way of winding spiral ply cords of an adaptive pitch rotation blade according to an embodiment of the present invention. In this embodiment, as shown in the figure, layers of plies of cords 903 are wound in a spiral manner around a rubber layer 904 to maintain its shape and to provide spring action for twisting motion. As shown in the figure, rib 905 and rib 902 are provided at respective ends. Hole 901 for accepting a spar shaft is provided at the leading edge of the blade. The orientations and density of the cords 903 determine mechanical performance. A lateral ply of cord may also be provided along streamline to maintain the airfoil shape unchanged against the dynamic pressure of flowing water. This way, the aerodynamic L/D (lift/drag) coefficient of airfoil can be kept high, and power conversion efficiency stays high. For example, the L/D coefficient can be higher than 20 and the power conversion efficiency may be as high as 30%. The lateral ply allows the rubber body to easily twist. Without lateral ply, in some circumstances, the rubber blade may be curved easily by the lift force, and degrades aerodynamic performance, for example, L/D becomes lower than 10, thereby lowering the power conversion efficiency. The spiral ply of cords 903 around spar hole provides for proper spring action for twisting of blade. The cords 903 may be nylon, polyester, or Aramid fibers or Kevlar. Diameter of the cord may be in the rage of 0.01 to 0.5 mm, for example. Production process of the plies and the blade may follow the same process as the pneumatic tire production.

FIG. 10 shows the adaptive pitch rotation blade for which the spiral and lateral ply cords are wound in accordance with the method explained with reference to FIG. 9. As explained above, the blade of this embodiment includes lateral cord 1006, spiral ply cord 1005, spiral ply cord 1001 wound around the inner rubber layer 1002. In addition, the structure explained with reference to FIG. 9 above is wrapped by an outer rubber layer 1007, thereby constituting a blade 1008 of this embodiment for a WEC unit. A hole 1004 is provided at the leading edge of the blade in order to accept a spar shaft having an axis 1003. As shown in this figure, in this embodiment, plies of cords are provided inside the blade. This way, using the blade 1008 of the present embodiment, the resulting WEC unit can have adaptive pitch rotating blades, the pitch (twisting angle) of which can elastically changes in response to impinging waves (water flow). In other words, auto-regulated torque limiting occurs.

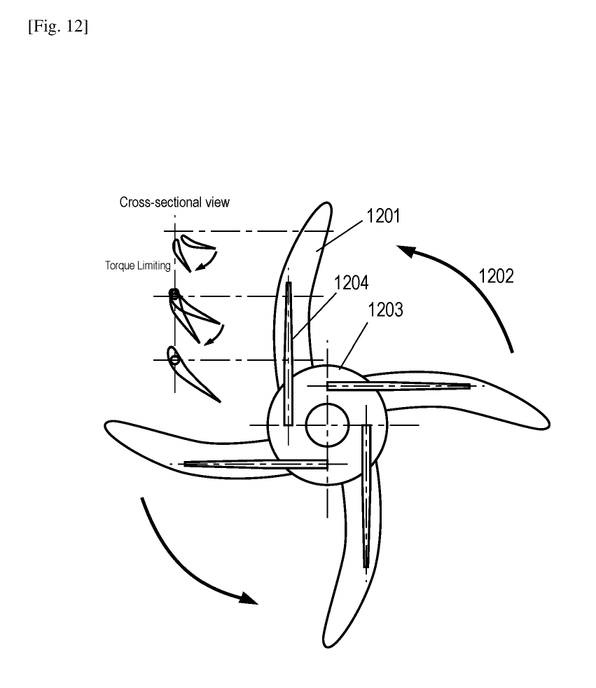

FIG. 12 shows an adaptive pitch rotation blade according to yet another embodiment of the present invention. In this embodiment, a portion closer to the base of a blade 1201 (side closest to the rotor axis) is fixed to the rotor hub 1203 with a spar 1204 with a large initial twist angle, for example, 30 to 60 degree. The cross-section of the blade 1201 has an airfoil shape, with asymmetric concave design. NACA data for airfoil design can be utilized to determine the cross-sectional shape of this type. Up to near the aerodynamic center, i.e., 25% of the cord length from the leading edge, the hole for spar 1204 is made in the blade 1201. The spar location is shifted to the front side at outer sections, and the blade can be bent backward to the tailing side. The spar 1204 is a straight spar (central shaft) with a circular cross-section that is inserted into the hole for each blade and is fixed to the main rotor shaft through the rotor hub 1203. The blade 1201 is made by a soft material, and is configured to twist easily around the central shaft. The neutral twist (at rest condition with no water flow) is made smaller toward wingtip. When the water flow rate increases, because of the lift force on the blade and force center is offset from the central shaft (spar 1204), torque is created, which flips down the blade and lowering force acting on blade, to protect the blade from breakage. As shown in the cross-sectional views of the blade inserted in FIG. 12, near its tip, the blade 1201 is twisted elastically at a larger angle in response to incoming water flow/waves, and is twisted elastically at a relatively small angle at the middle. At the bottom, the blade 1201 is hardly twisted. The present embodiment realizes the adaptive pitch in this way.

Any of the embodiments for the adaptive pitch blade described above can be used in the WEC units shown in FIGS. 1, 3, and 4A-4B, for example. In the case that the WEC unit shown in FIG. 3 is provided with such adaptive pitch blades, when the waves reach the turbine 304, the water flow hits the blades, and creates drag force, which twists the blade into a propeller shape, followed by starting rotation and flying the blade in the water. As a result, fluid-dynamic lift force appears, which further accelerates the turbine rotation. The kinetic energy of rotation is converted into electricity through the generator 306, and the generated electricity is sent to an onshore power station through electric power line 307. For the backward flow, the twist angle reverses and rotates the turbine in the same direction.

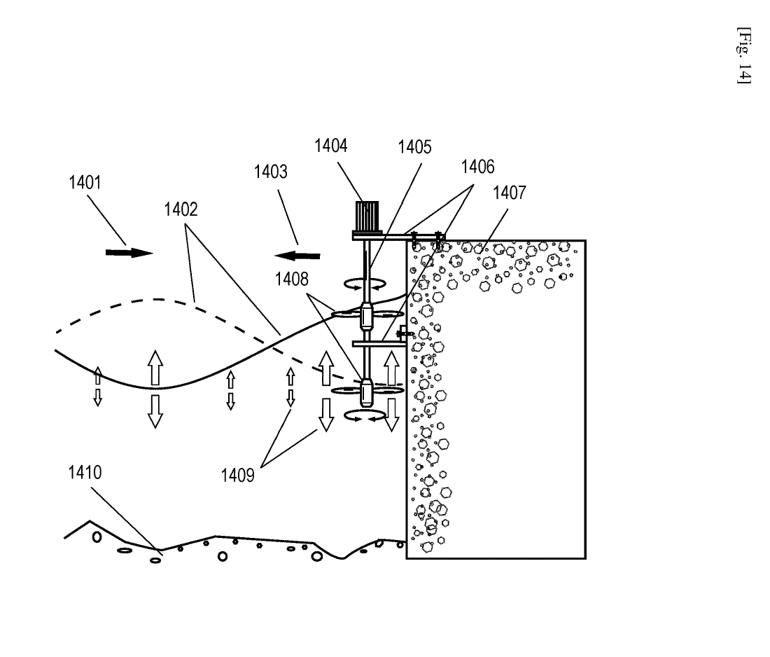

FIG. 14 shows another example of installation of WEC units at a shoreline according to an embodiment of the present invention. The incoming ocean wave 1401 is reflected at a wall (in this example, a vertical wall) of the breakwater (or quay) 1407, and the resulting combination of the reflected wave 1403 and the incoming wave 1401 creates oscillating standing wave 1402 at the water surface, which causes the water near the breakwater wall to move vertically up and down. Importantly, the amplitude of standing wave is almost twice of incoming wave. Therefore, there exists fast vertical flows. The turbines of the present embodiment harness energy from this vertical water flow. Specifically, turbines 1408 (any of the WEC units described herein) are installed together with electric generator 1404 along the vertical wall of the breakwater 1407, instead of on the sea floor 1410, so that the vertical water flow (i.e., oscillating water flow 1409) is converted to electricity through the electric generator 1404. The turbines 1408 and the electric generator 1404 are supported by a support structure 1406 mounted to the breakwater 1407. To cope with, or to effectively utilize, changes in the mean water level due to tides, two or more turbines (blade sets) 1408 may be installed on the same rotor shaft 1405, as shown in FIG. 14. Also, by harnessing energy from oscillating water flow, this WEC can effectively act as a wave breaking structure.

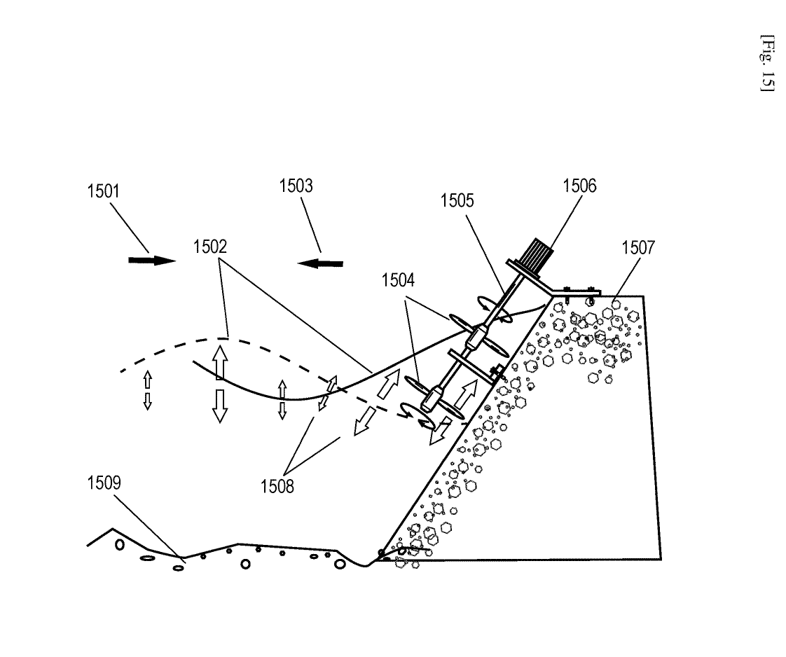

FIG. 15 shows yet another example of installation of WEC units at a shoreline according to an embodiment of the present invention. When the breakwater or quay 1507 has a slope, the water flows along the slope. To harness energy, the turbine (i.e., any of the WEC units described herein) may be installed in parallel to the slope, instead of on the sea floor 1509. Incoming wave 1501 creates standing wave 1502 as a result of being combined with the reflected wave 1503, and the resulting oscillating water flow 1508 causes the turbines 1504 to rotate, which causes the rotor shaft 1505 to rotate, thereby generating electric power at electric generator 1506. Similar to the structure shown in FIG. 14, considering sea level changes due to tides, multiple turbines (blade sets) 1504 may be provided. Further, by harnessing energy from oscillating water flow, this WEC can also act as an effective wave breaking structure.

It will be apparent to those skilled in the art that various modification and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

1. A wave energy converter system, comprising:
a plurality of wave energy converter units installed at or adjacent to a shoreline to receive water flows caused by ocean waves approaching the shoreline, each of the wave energy converter units including:
a generator having a rotor shaft, the generator being configured to generate electricity in accordance with rotation of the rotor shaft; and
a plurality of blades attached to the rotor shaft, the plurality of blades causing the rotor shaft of the generator to rotate in response to the water flows that impinge on the blades, thereby generating electricity; and
a power conditioner installed onshore to receive the electricity generated by each of the plurality of wave energy converter units, the power conditioner providing consolidated electricity to an external power grid.

2. The wave energy converter system according to claim 1, wherein the plurality of wave energy converter units are installed on an ocean floor adjacent to the shoreline.

3. The wave energy converter system according to claim 1, wherein the plurality of wave energy converter units are installed on a vertical or inclined wall of a breakwater or quay structure.

4. A wave energy converter unit with adaptive pitch blades for converting ocean wave energy to electric power, comprising:
a generator having a rotor shaft, the generator being configured to generate electricity in accordance with rotation of the rotor shaft; and
a plurality of adaptive pitch blades attached to the rotor shaft, the plurality of blades causing the rotor shaft of the generator to rotate in response to water flows of ocean waves that impinge on the blades, thereby generating electricity,
wherein each adaptive pitch blade has a spar shaft at a leading edge of the blade, the spar shaft being fixed to the rotor shaft and radially extending from the rotor shaft, and
wherein at least some segments of the blade are configured to be elastically rotatable around the spar shaft relative to a prescribed neutral rest position so that said at least some segments of the blade can change a pitch angle relative to the spar shaft in response to the water flows of the ocean waves that impinge on the blade.

5. The wave energy converter unit according to claim 4, wherein said prescribed neutral rest position is such that the blade is positioned within a plane of rotation as defined by the rotor shaft.

6. The wave energy converter unit according to claim 4, wherein the pitch angle gradually change from zero to an angle close to 90 degrees as a flow rate of the water flows of the ocean waves increases.

7. The wave energy converter unit according to claim 4, wherein the blade has symmetrical cross-section at the prescribed neutral rest position relative to a plane of rotation as defined by the rotor shaft.

8. The waver energy converter unit according to claim 4, wherein at least some segments of the blade that are configured to be elastically rotatable around the spar shaft are provided with ply cords laterally wound along a streamline of the blade so as to maintain an airfoil shape of the blade in response to the water flows of the ocean waves that impinge on the blade.

9. The waver energy converter unit according to claim 4, wherein at least some segments of the blade that are configured to be elastically rotatable around the spar shaft include:
an inner blade layer;
ply cords that are laterally wound along a streamline of the inner blade layer; and
an outer blade layer that covers the inner blade layer having the ply cords wound thereon so as to maintain an airfoil shape of the blade in response to the water flows of the ocean waves that impinge on the blade.

10. The waver energy converter unit according to claim 9, wherein said at least some segments of the blade further include ply cords that are spirally wound on the inner blade layer.

11. The waver energy converter unit according to claim 9, wherein the inner blade layer and the outer blade layer are made of rubber.

12. A wave energy converter system, comprising:
a plurality of wave energy converter units as set forth in claim 4, installed at or adjacent to a shoreline to receive water flows caused by ocean waves approaching the shoreline;
a power conditioner installed onshore to receive the electricity generated by each of the plurality of wave energy converter units of claim 4, the power conditioner providing consolidated electricity to an external power grid.
